(19) United States
(12) Patent Application Publication
(10) Pub. No.: US 2001/0028795 A1
(43) Pub. Date: Oct. 11, 2001

(54) Camera

(76) Inventor: Kazushige Ichino, Tokyo (JP)

Correspondence Address: ROBIN BLECKER & DALEY, 2ND FLOOR, 330 MADISON AVENUE, NEW YORK, NY, 10017, US

(21) Appl. No.: 09/823,462

(22) Filed: Mar. 30, 2001

(30) Foreign Application Priority Data
Apr. 6, 2000 (JP) 2000-104772

(51) Int. Cl. G03B 17/02

(52) U.S. Cl. 396/266; 396/536

(57) ABSTRACT

A camera includes an operation member operable for bringing a back lid or a cartridge chamber lid from a closed state into an open state, a lock member arranged to be displaceable between a first position in which the lock member permits an opening operation on the operation member and a second position in which the lock member inhibits the opening operation, and an interlocking member arranged to displace the lock member from the first position to the second position in association with a film beginning to move in a winding direction thereof. The interlocking of the interlocking member with the lock member is cut off in response to the lock member having been displaced to the second position.

### BACKGROUND OF THE INVENTION

1. Field of the Invention

The present invention relates to an improvement on a camera having lock means for locking an operation member which is provided for opening a back lid or a cartridge chamber lid of the camera from a closed state thereof.

2. Description of Related Art

A camera is provided with a cartridge chamber for housing a film cartridge therein, a spool chamber in which a take-up spool is disposed, and a pressing plate receiving part on which photo-taking light comes to fall. Then, the camera is further provided with a back lid which is openable and closable for preventing external light from entering the cartridge chamber, the spool chamber and the pressing plate receiving part of the camera. To ensure that the back lid is not readily opened by the vibration of the camera or the like, there is provided an opening-and-closing mechanism which includes a lock claw, etc. The opening-and-closing mechanism is arranged to permit the user of the camera to unlock the lock claw as desired by operating the opening-and-closing mechanism. However, if the back lid happens to be opened by mistake while an exposed film is still within the spool chamber in a state of being wound on the take-up spool, the film used for photo-taking with efforts would be ruined by being exposed to external light.

In the case of a camera adapted for the Advanced Photo System (APS), which has been put on the market in recent years, an opening-and-closing mechanism arranged to permit opening the lid of a cartridge chamber as desired also has the same problem. If the cartridge chamber lid happens to be opened by mistake, a film would be exposed to external light through the cartridge chamber.

To solve the problem, a mechanism whereby an opening operation on the opening-and-closing mechanism for a back lid or a cartridge chamber lid is inhibited under specific conditions, i.e., an erroneous-opening inhibiting mechanism, has been variously developed. The following describes some examples of such an arrangement.

### First Example of Prior Art (Japanese Laid-Open Patent Application No. Hei 9-211618)

This example is an erroneous-opening inhibiting mechanism for a camera of the kind using the APS film cartridge. The erroneous-opening inhibiting mechanism is arranged to restrict the movement of a knob provided for opening a cartridge chamber lid, in association with the rotation of a transport gear train which is provided for thrust-driving and rewinding-driving the film. More specifically, the erroneous-opening inhibiting mechanism is arranged to lock the cartridge chamber lid opening knob while the transport gear train is rotating for a winding rotation including a thrust-driving action and also after the rotation in this direction has come to a stop. The cartridge chamber lid opening knob is locked by a lock member which is arranged to rotate through a frictional contact with a gear included in the transport gear train.

In the case of this mechanism, the lock is not applied to leave the cartridge chamber lid in an openable state while the transport gear train is rotating in the direction of film rewinding and also after the rotation in this direction has come to a stop.

### Second Example of Prior Art (Japanese Laid-Open Patent Application No. Hei 7-199305)

The second example of prior art is an erroneous-opening inhibiting mechanism developed also for a camera of the kind using the APS film cartridge. The erroneous-opening inhibiting mechanism includes a lever which is arranged to directly detect the presence or absence of film. When the film is outside of the film cartridge, the lever is pushed by the film in such a way as to lock a lid opening-and-closing member.

Compared with the first example of prior art, the arrangement of the second example of prior art prevents the cartridge chamber lid from being opened by mistake also while the film is in a state of being rewound and is not completely taken up inside of the film cartridge.

### Third Example of Prior Art (U.S. Pat. No. 4,149,793)

The third example of prior art is a mechanism developed for a camera of the kind using the so-called 135 film. The erroneous-opening inhibiting mechanism is arranged to interlock a back lid opening mechanism with a film rewinding mechanism by using a detecting lever which is provided for detecting the presence or absence of the film. More specifically, while the camera is in a state of performing a film rewinding action with a film rewinding lever, when the state of the detecting lever changes to a state of indicating the absence of the film with a predetermined amount of film rewound back into a film cartridge, the rotating force for the film rewinding is transmitted to the back lid opening mechanism to cause the back lid of the camera to open.

Although this mechanism is, to be exact, not an erroneous-opening inhibiting mechanism, the arrangement of the third example of prior art is capable of reliably preventing the back lid from being opened by mistake, as there is no opening operation member.

Besides the cameras which are arranged to control an erroneous-opening inhibiting mechanism in the above-stated manners, cameras have been developed to control various actions according to the presence or absence of a film or according to the presence or absence of a film cartridge. For example, some of them have been arranged to perform control to inhibit a flash device from emitting light according to the absence of a film cartridge, for the purpose of saving electric energy.

As mentioned above, the known erroneous-opening inhibiting mechanisms have been arranged either to use the driving force of the film transport mechanism provided for winding and rewinding the film or to use the result of detection of the presence or absence of the film. The arrangement of these known mechanisms is, however, hardly applicable to both of the different kinds of cameras, one using the 135 film and the other using the APS film cartridge.

This is because the cameras of these two kinds differ from each other in the manner of carrying out an automatic loading (AL) action which is performed to wind the film on the take-up spool in loading the camera with the film. The APS film cartridge can be handled in a state of having the leader part of film not protruding to the outside of the cartridge. In other words, in the APS film cartridge, a rewinding fork gear is arranged to thrust-drive the film in such a way as to send out the film until the film is taken up and wound around a take-up spool. Therefore, the user can handle the APS film cartridge without touching the film. On the other hand, the 135 film necessitates the user to manually bring the leader part of the film onto the take-up spool.

With the erroneous-opening inhibiting mechanisms of prior art described above assumed to be applied to a camera which is arranged to use the 135 film and has a film transport mechanism for winding and rewinding the film by means of a motor, there arise the following problems.

In the case of the first example of prior art, the erroneous-opening inhibiting mechanism is controlled according to the rotating direction of the transport gear train irrespective of the presence or absence of film. The term “irrespective of the presence or absence of film” includes a case where no film cartridge exists within the camera to begin with as well as to a case where there is no film which is in process of being transported. Therefore, in the event of a failure in AL (automatic loading), with the camera adapted for use of the 135 film, the camera action to be performed after the AL failure brings forth a problem.

Generally, the AL failure is caused not only by a mechanical factor of the camera itself but also by an insufficient extent to which the leader part of the film is pulled out to be wound around the take-up spool. In some possible cases, the camera performs an AL action on its own initiative when the back lid is closed without loading any film cartridge into the camera. In such a case, the absence of a film causes the camera to erroneously decide the AL action to have failed.

In these cases, although the occurrence of the AL failure is decided, the camera is performing a film winding action and the transport gear train is also rotating for the film winding. As a result, the erroneous-opening inhibiting mechanism acts on the back lid opening-and-closing mechanism to hinder the back lid from being opened. Therefore, in a case where the AL action is decided to have failed, it is necessary to tentatively perform a film rewinding action and then to cancel the action of the erroneous-opening inhibiting mechanism in association with the rewinding rotation of the transport gear train. In this instance, if the film is inside of the camera, a relatively large portion of the leader part of the film is drawn into the film cartridge.

Further, in this instance, if the user does not understand the reason for the AL failure and repeatedly closes the back lid without pulling out the leader part of the film, while seeing only an apparently normal state of the film cassette by opening the back lid, the camera repeats the film rewinding action. Then, the protruding amount of the film leader part decreases every time the back lid is repeatedly closed. The leader part of the film is thus eventually pulled completely into the film cassette because the 135 film is not arranged to be thrust-driven.

Further, in the case of the first example of prior art, a locking action is performed by a lock member which is arranged to rotate through a frictional contact with some of gears of the transport gear train. However, this friction is applied to the whole transport gear train to impose a load on the film transport.

The second example of prior art is arranged to detect the presence or absence of a film by means of a lever. Therefore, if the pulled-out length of the leader part of film is short, the lever does not act to render the erroneous-opening inhibiting mechanism operative. Such being the arrangement, the back lid of the camera can be opened even after the AL failure. Therefore, unlike the first example of prior art, the second example does not necessitate any film rewinding action. However, the AL failure takes place also in a case where the film leader part is pulled out too much. If the back lid is closed with the film leader part pulled to an excessive extent, the lever detects the film to render the erroneous-opening inhibiting mechanism operative the instant the back lid is closed irrespective of a failure or no failure of the AL action. Under such a condition, it tends to become impossible to open the back lid without performing the rewinding action in the same manner as in the case of the first example of prior art described above. Besides, in that event, the excessively pulled-out film leader part must be rewound until the lever ceases to detect the film leader part. However, since the excessive amount is not fixed, the rewinding action must be carried out to a substantially sufficient extent. Then, in a case where the AL failure takes place with the film leader part pulled out to a relatively short extent, the film leader part would be completely pulled in by performing the rewinding action only once. This is also because the 135 film is not arranged to be thrust-driven.

The third example of prior art is free from the above-stated problems of the first and second examples as the mechanism is developed for the use of the 135 film to begin with. The camera is arranged to perform a film rewinding action in such a way as to rewind the film leaving a certain predetermined amount of the film leader part outside of the film cartridge. When the lever detects the absence of film, the back lid of the camera opens of its own accord. Since the film rewinding rotation of a fork gear is restricted at that time, the leader part is never pulled in any further.

However, since the back lid is arranged to open at the same time as the completion of the film rewinding action, a camera of the kind having an automatic rewinding mechanism allows its back lid to open of its own accord irrespective of the intention of the user. Further, like in the case of the second example of prior art, the film detecting lever directly pushes the film while the film is in process of film transport to impose a load on the film transport process.

The foregoing is a first problem.

In addition, some of known cameras are arranged to detect the presence or absence of a film cartridge and to inhibit, according to the result of detection, a specific action such as light emission from a flash device or the like. For detecting the presence or absence of a film cartridge, a contact piece is arranged within a cartridge chamber to abut on a conductive part provided on the surface of the film cartridge. However, if the contact piece or the surface of the film cartridge is smeared or unclean, the conductivity between the contact peace and the surface of the film cartridge would be lost, thereby making the above-stated control impossible.

The foregoing is a second problem.

### BRIEF SUMMARY OF THE INVENTION

In accordance with one aspect of the invention, there is provided a camera, comprising an operation member operable for bringing a back lid or a cartridge chamber lid from a closed state into an open state, a lock member arranged to be displaceable between a first position in which the lock member permits an opening operation on the operation member and a second position in which the lock member inhibits the opening operation, an interlocking member arranged to displace the lock member from the first position to the second position in association with a film beginning to move in a winding direction thereof, and holding means for holding the lock member in the second position by cutting off the interlocking of the interlocking member with the lock member in response to the lock member having been displaced to the second position.

The above and other aspects and features of the invention will become apparent from the following detailed description of preferred embodiments thereof taken in connection with the accompanying drawings.

### BRIEF DESCRIPTION OF THE SEVERAL VIEWS OF THE DRAWINGS

FIG. 1 is a diagram showing the operating states of members obtained in the event of an AL failure in a camera according to a first embodiment of the invention.

FIG. 2 is a diagram showing the operating states of members obtained at the time of a recovery operation in the camera according to the first embodiment of the invention.

FIG. 3 is a diagram showing the operating states of members obtained when the AL action is successfully carried out in the camera according to the first embodiment of the invention.

FIG. 4 is a diagram showing the operating states of members obtained at the time of the film rewinding in the camera according to the first embodiment of the invention.

FIG. 5 is a diagram showing the operating states of members obtained in the event of an AL failure in a camera according to a second embodiment of the invention.

FIG. 6 is a diagram showing the operating states of members obtained at the time of the film rewinding in the camera according to the second embodiment of the invention.

FIG. 7 is a bottom view showing essential parts of a camera according to a third embodiment of the invention.

FIG. 8 is a front sectional view showing essential parts of the camera according to the third embodiment of the invention.

FIG. 9 is a partial perspective view showing essential parts of the camera according to the third embodiment of the invention.

FIG. 10 is a diagram showing the operating states of members obtained in the event of an AL failure in the camera according to the third embodiment of the invention.

FIG. 11 is a diagram showing the operating states of members obtained when the AL action is successfully carried out in the camera according to the third embodiment of the invention.

FIG. 12 is a diagram showing the operating states of members obtained at the time of a change-over to the film rewinding in the camera according to the third embodiment of the invention.

FIG. 13 is a diagram showing the operating states of members obtained at the time of the film rewinding in the camera according to the third embodiment of the invention.

FIG. 14 is a diagram showing the operating states of members obtained when the AL action is successfully carried out in a camera according to a fourth embodiment of the invention.

FIG. 15 is a diagram showing the operating states of members obtained at the time of a change-over to the film rewinding in the camera according to the fourth embodiment of the invention.

### DETAILED DESCRIPTION OF THE INVENTION

Hereinafter, preferred embodiments of the invention will be described in detail with reference to the drawings.

### First Embodiment

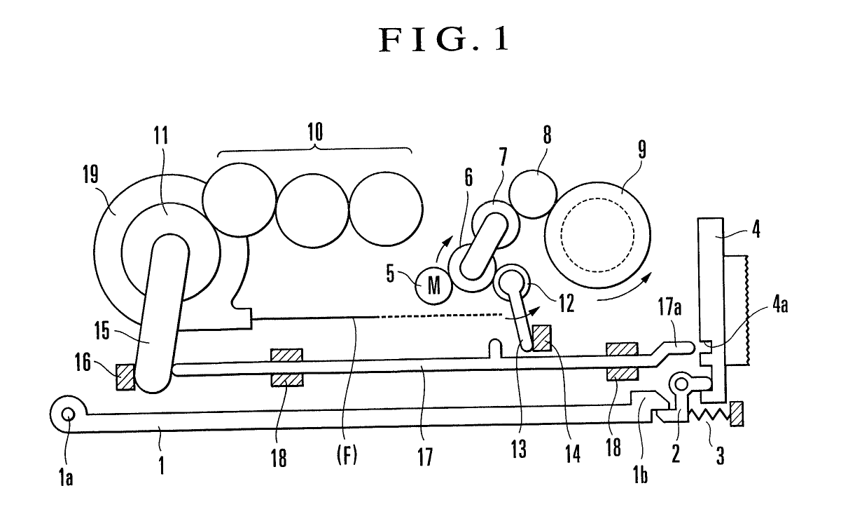

FIGS. 1 to 4 relate to a camera according to a first embodiment of the invention. Each of FIGS. 1 to 4 shows a film transport mechanism and an erroneous-opening inhibiting mechanism applied to the camera in the form of a model arrangement. Base plates and other parts which are arranged to hold these mechanisms in actuality are omitted from the illustration. Then, FIGS. 1 to 4 show the parts of the mechanisms in different states and positions.

Referring to FIG. 1, the functions of the parts of the above-stated mechanisms are first described.

A back lid 1 is held in such a way as to be swingable on an axis of rotation 1a to open and close. An opening-restricting pawl 2 is arranged to push up a claw part 1b of the back lid 1 under the force of a closing spring 3 in such a way as to prevent the back lid 1 from being inadvertently opened. A back-lid opening knob 4 is arranged to enable the user of the camera to open the back lid 1 by pushing the back-lid opening knob 4 upward as viewed in FIG. 1. With the back-lid opening knob 4 pushed up, the opening-restricting pawl 2 is caused to swing counterclockwise against the force of the closing spring 3, so that the back lid 1 can be opened.

A film transport gear train is arranged to rotate in the directions of film winding and film rewinding by receiving the rotating force of a motor 5. The force of counterclockwise rotation of the motor 5 causes a take-up spool 9 to rotate counterclockwise through a sun gear 6, a planet gear 7 and a winding idler gear 8. The force of clockwise rotation of the motor 5 causes a fork gear 11 to rotate clockwise through the sun gear 6, the planet gear 7 and a rewinding idler gear train 10.

The planet gear 7 is arranged to switch the transmission of a film winding rotating force over to that of a film rewinding rotating force by revolving around the sun gear 6. In addition to the planet gear 7, a release gear 12 is in mesh with the sun gear 6. A release lever 13 is arranged to be swingable coaxially with the release gear 12 and to swing in the same direction as the release gear 12 through a frictional force. The release lever 13, which is thus arranged to receive the rotating force of the release gear 12, is, however, not allowed to swing unrestrictedly under the rotating force of the release gear 12, but is allowed to swing only to a predetermined angle of rotation by a limitation imposed by a release-lever stopper 14 and another part (a knob lock 17). The limitation is imposed in such a manner that the release lever 13 slips when the release gear 12 rotates further than the predetermined angle of rotation.

A lock lever 15 is held by the fork gear 11 in such a way as to be swingable coaxially with the fork gear 11. The relation of the lock lever 15 to the fork gear 11 is the same as that of the release lever 13 to the release gear 12. In other words, like the release lever 13, the lock lever 15 is allowed to swing only to a predetermined degree of angle defined by a lock lever stopper 16 and the knob lock 17, and is thus arranged to slip even when the fork gear 11 rotates further than this angle of rotation.

As described above, the user of the camera can open the back lid 1 by pushing up the back-lid opening knob 4. However, the movement of the back-lid opening knob 4 in the direction of opening the back lid 1 is restricted by the knob lock 17. The knob lock 17 is arranged to be slidable horizontally, as viewed in FIG. 1, under the guidance of guide parts 18. When the knob lock 17 is caused to move to the right, as viewed in FIG. 1, by a force which will be described later, an engaging part 17a of the knob lock 17 is thrust into a recessed part 4a of the back-lid opening knob 4 to restrict the upward movement of the back-lid opening knob 4. Besides horizontally guiding the knob lock 17, the guide parts 18 are arranged to prevent, with friction, the knob lock 17 from being readily moved horizontally by its own weight, etc.

FIG. 1 shows the camera in a state in which a film cartridge 19 is set within a cartridge chamber (not shown), a film F is pulled out to a certain extent from the film cartridge 19, the back lid 1 is closed, and an AL (automatic loading) action has begun.

Various actions to be performed by the camera are next described with reference to FIGS. 1 to 4.

### AL Failure

FIG. 1 shows the camera in a state of having failed to take up and wind the film F on the spool 9 because the pulled-out amount of the film F is either too short or too long.

In this instance, the motor 5 makes film winding rotation. The planet gear 7 revolves to mesh with the take-up spool 9 through the idler gear 8. The take-up spool 9 rotates counterclockwise. The release gear 12 continues to rotate counterclockwise. The release lever 13 is slipping after promptly coming to abut on the release-lever stopper 14. Under this condition, the position of the knob lock 17 is on the left side as viewed in FIG. 1, thereby rendering the back-lid opening knob 4 operatable in the direction of opening the back lid 1. The camera then can decide, by a known process, the AL action to have failed. With the AL action thus decided to have failed, the film winding rotation of the motor 5 is brought to a stop.

### Recovery

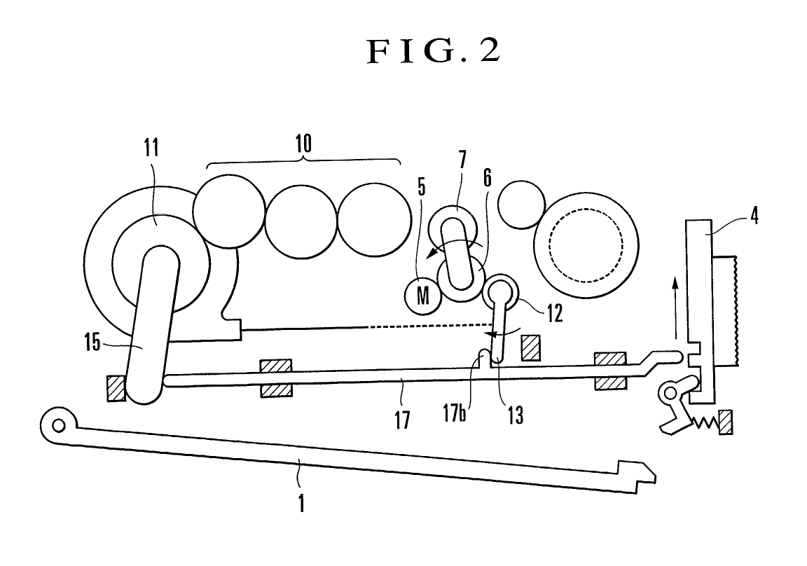

In the state thus obtained, the camera user can open the back lid 1 as desired. However, in view of the possibility that the knob lock 17 might be caused to move to the right as viewed in FIG. 1 by some reason, such as a shake or the like inflicted on the camera, the first embodiment is arranged to ensure that the back lid 1 can be opened by causing the motor 5 to rotate in the direction of film rewinding, as shown in FIG. 2. The amount of rewinding rotation for this purpose is not so much as to bring the film completely back into the film cartridge, as mentioned in the foregoing description of prior art. The rewinding rotation is made only to a small amount obtained by having the motor 5 make rewinding rotation to cause the planet gear 7 to revolve counterclockwise to such a small degree that the planet gear 7 does not come to mesh with the rewinding gear train 10 or, even if it does, the fork gear 11 is not caused to make a rewinding rotation to any substantial degree.

When the motor 5 makes the rewinding rotation, the rotating force of the motor 5 is transmitted through the sun gear 6 to the release gear 12 as a clockwise rotating force. This causes the release lever 13 to push a release projection 17b of the knob lock 17 to reliably have the knob lock 17 at its left side position. In this instance, the swinging angle of the release lever 13 is sufficiently small so that a releasing (recovery) action can be adequately performed with a slight amount of rotation of the motor 5.

However, if there is no fear that the knob lock 17 might be inadvertently moved, the above-stated action may be unnecessary.

### Successful AL

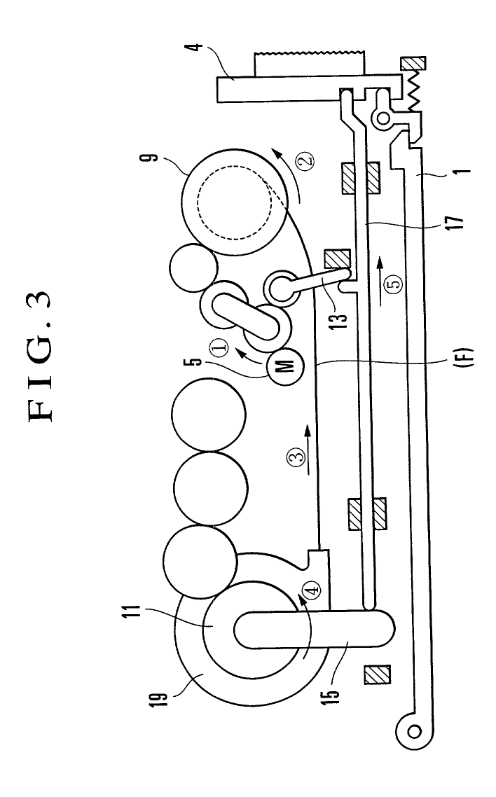

FIG. 3 shows a state obtained after the AL action is successfully performed with the film F adequately taken up and wound on the take-up spool 9. In FIG. 3, arrows with numerals indicate the direction and sequence (\mathring{1} to \mathring{5}) of movement of the essential parts before the erroneous-opening inhibiting mechanism becomes operative.

The rotating force of the motor 5 is first transmitted to the take-up spool 9. The film F begins to be wound on the take-up spool 9. Then, the film F begins to be pulled out from the film cartridge 19. The fork gear 11 begins to rotate counterclockwise. A camera adapted for the use of the APS film cartridge is provided with a mechanism for sending the film out from the film cartridge. In the camera of that kind, the fork gear 11 can be caused to rotate either clockwise or counterclockwise. In the case of a camera adapted for the use of the 135 film, on the other hand, the fork gear 11 is normally rotatable by the motor 5 only in the clockwise direction, which is the film rewinding direction. However, in a case where the film F is in a pulled-out state, the fork gear 11 can be rotated in the counterclockwise direction. The rotating force of the fork gear 11 is transmitted to the lock lever 15 to cause the lock lever 15 to push the knob lock 17 to the right, as viewed in FIG. 1. The back-lid opening knob 4 is locked under this condition. The back lid 1 becomes no longer openable by the operation of the user.

As apparent from the description given above, a feature of the first embodiment lies in that the back-lid opening knob 4 is locked, i.e., the erroneous-opening inhibiting mechanism (the release gear 12, the release lever 13, the lock lever 15 and the knob lock 17) is rendered operative, when the film F has substantially begun moving after the AL action is successfully carried out. With the first embodiment arranged in this manner, in the event of a failure of the AL action, the erroneous-opening inhibiting mechanism is not rendered operative, because no substantial movement of the Film takes place, so that the back lid 1 can be opened as desired.

The locked state continues after the motor 5 comes to a stop to wait for photo-taking with the AL action carried out. This state likewise continues also after the completion of a one-frame winding action which follows every time a single-frame shot is taken. The arrangement thus effectively prevents the back lid 1 from being opened by any inadvertent operation on the back-lid opening knob 4.

### Rewinding

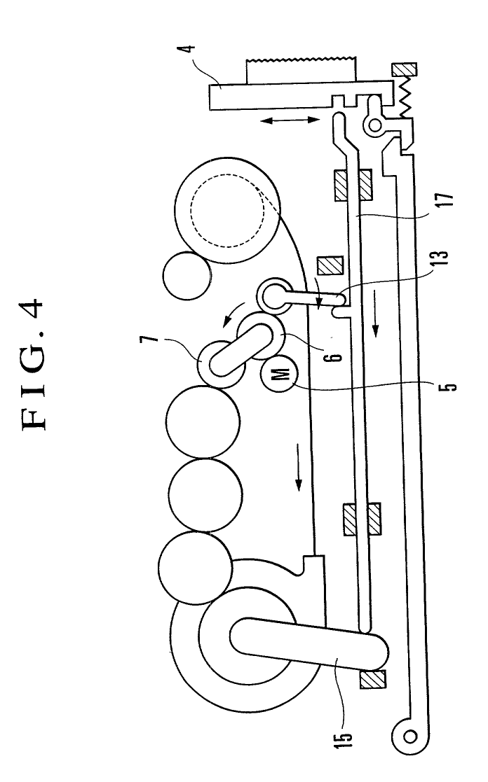

FIG. 4 shows a state obtained at the commencement of film rewinding after the completion of a predetermined number of shots.

In the case of the “recovery” action shown in FIG. 2, the motor 5 is caused to make rewinding rotation. However, the motor 5 is brought to a stop before the fork gear 11 is actually caused to begin rewinding rotation. At this point of time, the release lever 13 swings clockwise to move the knob lock 17 to the left to permit an opening operation on the back-lid opening knob 4.

If the motor 5 is allowed to continuously make the rewinding rotation in that state, a substantial film rewinding action begins to bring about the state shown in FIG. 4. Therefore, when the rewinding rotation of the motor 5 is performed, the erroneous-opening inhibiting mechanism is rendered inoperative to unlock the back lid 1. The unlocking action is, however, not performed when the film is caused to move by the substantial film rewinding action, but is performed while the revolving direction of the planet gear 7 is in process of change-over for film rewinding.

The first embodiment is arranged to lock the back-lid opening knob 4 in association with the rotation of the fork gear 11, which rotates when the film substantially moves in the winding direction. In the event of an AL failure, therefore, the erroneous-opening inhibiting mechanism is not actuated, as the film F (the fork gear 11) never moves, so that the back lid 1 can be opened.

The first embodiment is arranged to unlock the back-lid opening knob 4 in association with the rotation of the sun gear 6 when the sun gear 6 rotates to cause the planet gear 7 to revolve for change-over to the film rewinding action. Hence, the erroneous-opening inhibiting mechanism can be rendered inoperative before the film F begins to be substantially pulled back into the film cartridge. Therefore, even if the back lid 1 is operated repeatedly to open and close the back lid 1 in the event of successive failures of the AL action, the film F is never excessively pulled into the film cartridge, so that the recovery action may be safely performed every time the AL action fails.

Further, since the back lid 1 can be opened by performing the rewinding action irrespective of the presence or absence of the film cartridge 19 or the film F, the camera is recoverable from an abnormal state even in a case where the erroneous-opening inhibiting mechanism happens to be rendered operative by a strong shaking or the like.

### Second Embodiment

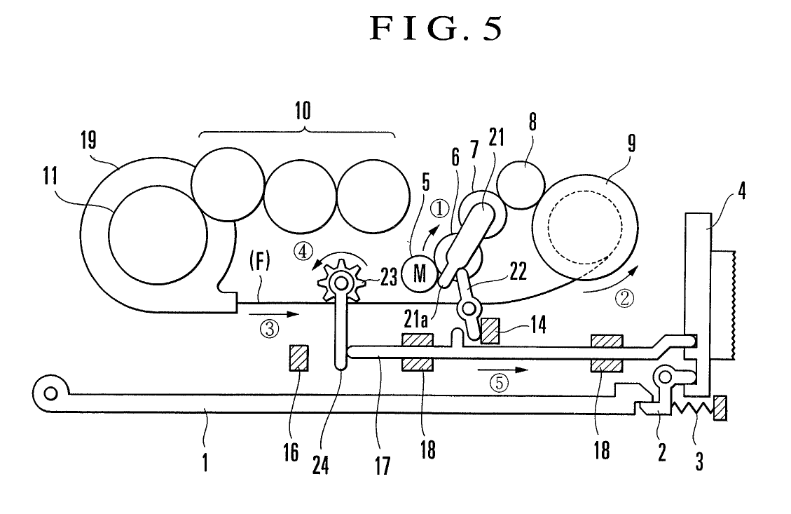

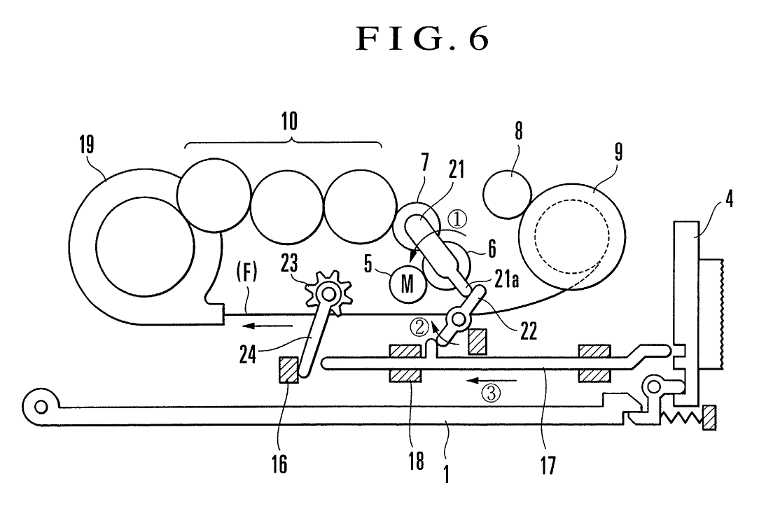

FIGS. 5 and 6 relate to a second embodiment of the invention. In the second embodiment, the arrangement of the first embodiment for rendering the erroneous-opening inhibiting mechanism operative, i.e., the arrangement including the mechanism for locking and unlocking the back-lid opening knob 4, is changed. All parts of the second embodiment that are in the same shape as those of the first embodiment are indicated by the same reference numerals, and the details of them are omitted from the following description of the second embodiment.

Like in the first embodiment described above, the timing for locking the back-lid opening knob 4 is the time when the film has substantially begun moving in the film winding direction after the AL (automatic film loading) action is successfully performed. In the case of the second embodiment, however, a sprocket 23 is used for detecting the movement of the film.

Similarly to the relation between the fork gear 11 and the lock lever 15 in the first embodiment, the sprocket 23 is provided with a second lock lever 24, which is held in such a way as to be swingable coaxially with the sprocket 23 and is arranged to slippingly rotate through a frictional force in the same direction as the direction of rotation of the sprocket 23. The knob lock 17 is arranged to be pushed to the right, as viewed in FIG. 5, by the second lock lever 24 when the second lock lever 24 rotates counterclockwise.

A part in the second embodiment corresponding to the release lever 13 in the first embodiment is a second release lever 22. The second release lever 22 is held in a simply swingable manner. One end of the second release lever 22 is arranged to be able to abut on a projection 21a provide on a planetary arm 21 which is arranged to hold the planet gear 7 for switching between film winding and film rewinding.

In the second embodiment arranged in the above-stated manner, an erroneous-opening inhibiting mechanism, which is composed of the knob lock 17, the projection 21a of the planetary arm 21, the second release lever 22, the sprocket 23 and the second lock lever 24, acts as follows.

### Successful AL

FIG. 5 shows a state in which the back-lid opening knob 4 is locked by the erroneous-opening inhibiting mechanism after the AL action is successfully performed. In FIG. 5, arrows with numerals indicate the direction and sequence (\mathring{1} to \mathring{5}) of movement of essential parts before the erroneous-opening inhibiting mechanism becomes operative. Before actually locking the back-lid opening knob 4, that is, when the back lid 1 is closed with the camera loaded with the film cartridge 19, the knob lock 17 is at the left end position, as viewed in FIG. 5.

The motor 5 first begins to make film winding rotation. This causes the take-up spool 9 to rotate counterclockwise through the sun gear 6, the planet gear 7 and the winding idler gear 8. Then, when the film F begins to move in the direction of the film winding with the AL action carried out successfully, the sprocket 23 begins to rotate counterclockwise to cause the second lock lever 24 to swing counterclockwise in association with the rotation of the sprocket 23. The counterclockwise swinging motion of the second lock lever 24 pushes the knob lock 17 to the right as viewed in FIG. 5. The knob lock 17 is thus caused to engage the back-lid opening knob 4 to render the back-lid opening knob 4 immovable.

The erroneous-opening inhibiting mechanism is thus arranged to be not rendered operative until the AL action is successfully carried out although the AL action begins after the back lid 1 is closed with the camera loaded with the film cartridge 19. Therefore, even in the event of an AL failure, the arrangement enables the user to perform a cartridge loading operation all over again by opening the back lid 1.

### Rewinding

FIG. 6 shows the erroneous-opening inhibiting mechanism in a state of having its action canceled in association with a film rewinding action.

After the completion of film winding, the motor 5 begins to rotate for film rewinding. The rotating force of the motor 5 is transmitted to the sun gear 6 and the planet gear 7. Then, the planet gear 7, which has been in mesh with the winding idler gear 8, begins to revolve counterclockwise to come to mesh with the rewinding gear train 10. The counterclockwise revolution of the planet gear 7 causes the planetary arm 21 to swing also counterclockwise. The projection 21a of the planetary arm 21 then causes the second release lever 22 to swing clockwise as viewed in FIG. 6. The clockwise swing of the second release lever 22 causes the knob lock 17 to move to the left. This causes the back-lid opening knob 4 to become operable for opening the back lid 1.

At this time, the planetary arm 21 swings counterclockwise. The knob lock 17 then moves to the left before the rewinding rotation force of the planet gear 7 is transmitted to the rewinding gear train 10. This arrangement necessitates no substantial rewinding action and is thus applicable to the “recovery” action as in the first embodiment described in the foregoing.

Another feature of the second embodiment lies in that the back lid 1 can be opened by carrying out a film rewinding operation irrespective of the presence or absence of the film cartridge 19 or the film F.

### Third Embodiment

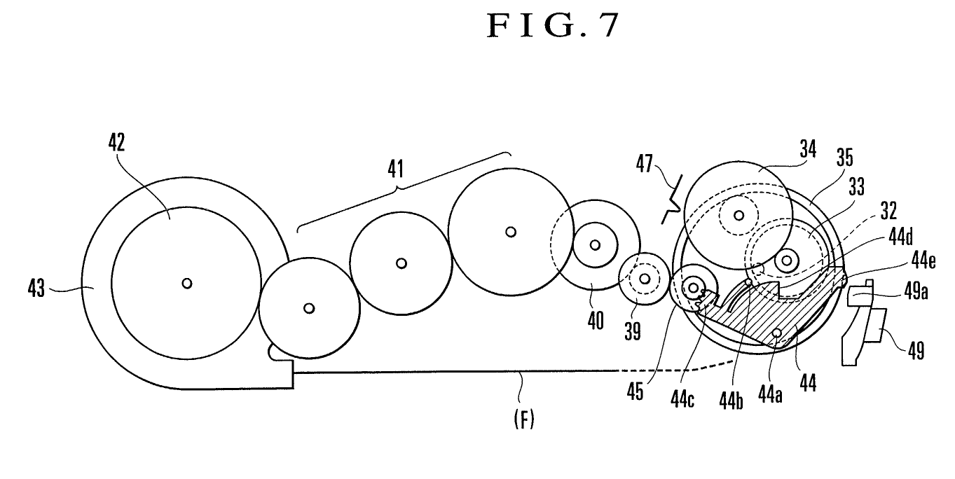

FIGS. 7 to 13 relate to a camera according to a third embodiment of the invention. In this case, the timing for rendering an erroneous-opening inhibiting mechanism operative, that is, the timing for locking a back lid, is obtained by interlocking the erroneous-opening inhibiting mechanism with the rotation in the film winding direction of a fork. The timing for canceling the action of the erroneous-opening inhibiting mechanism, that is, the timing for unlocking the back lid, is obtained by interlocking the erroneous-opening inhibiting mechanism with the revolution of a planet gear rotating for film rewinding. In other words, the arrangements of the first and second embodiments described above are combined in the third embodiment.

In each of the first and second embodiments, a film transport action is performed under a load constantly imposed by a frictional force exerted for swinging the lock lever 24 and the release lever 13. In addition to that, friction is provided at the guide parts 18 in such a way as to prevent the knob lock 17 from readily moving by its own weight. The first and second embodiments thus necessitate the lock lever 24 and the release lever 13 to push the knob lock 17 with forces larger than these frictional forces. Besides, frictional forces required for this purpose also must be constantly imparted to the lock lever 24 and the release lever 13. Such frictional forces increase the load on the film transport action.

To solve this problem, the third embodiment is arranged to impose no load on the film transport action while retaining the advantages of the first and second embodiments described in the foregoing.

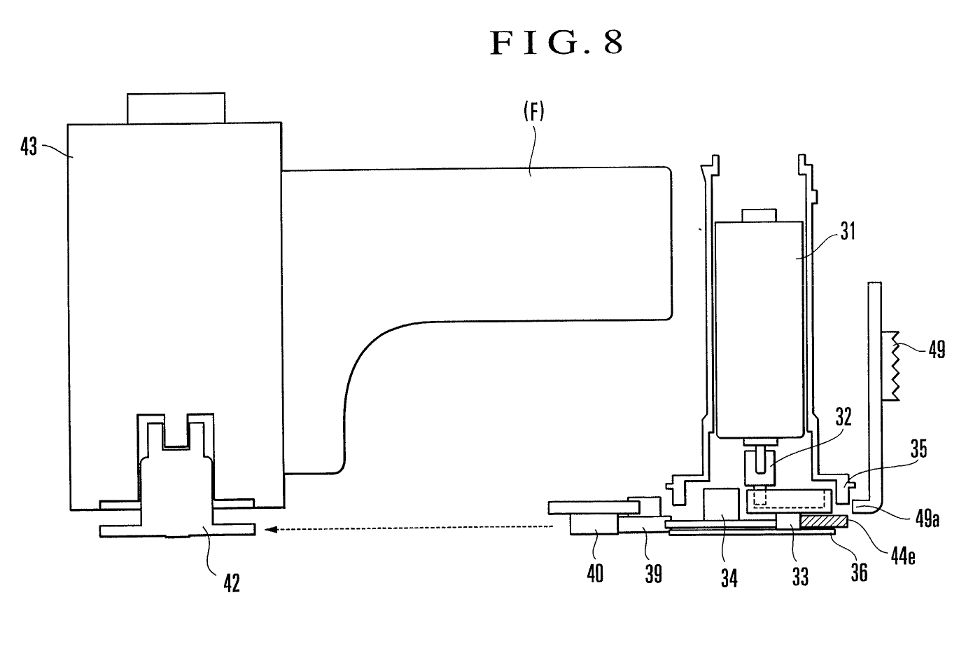

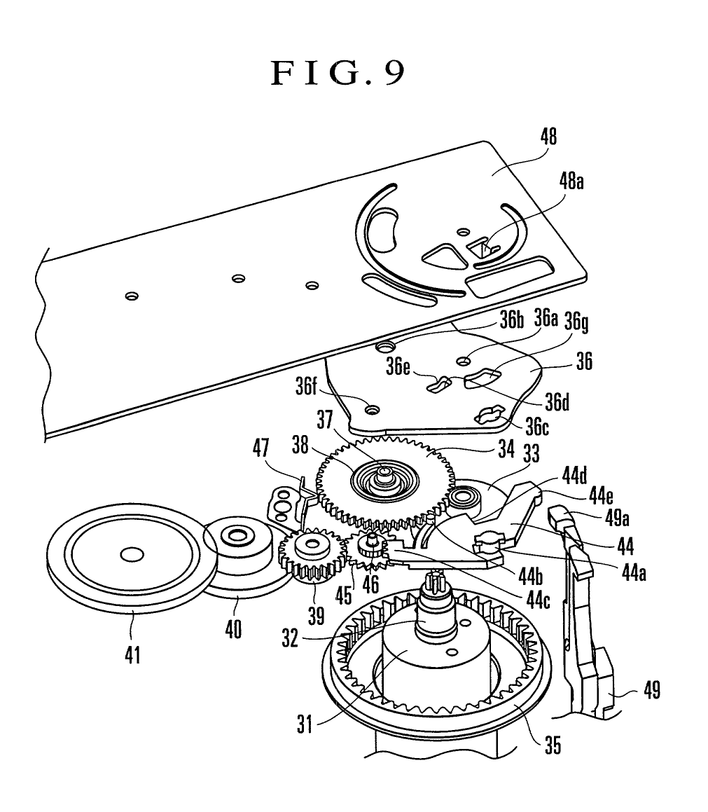

FIGS. 7 to 9 show an erroneous-opening inhibiting mechanism and a film transport mechanism applied to a camera as a model. The actual positional relation between these mechanisms, base plates holding them and other parts of the camera are omitted from FIGS. 7 to 9. Of FIGS. 7 to 9, FIG. 7 is a bottom view showing component members of the camera, FIG. 8 is a front view showing the component members, and FIG. 9 is a perspective view showing essential parts of the camera.

The arrangement of each of these members is described below referring to FIGS. 7, 8 and 9. Some of these members are shown only in some of FIGS. 7 to 9.

A motor 31 for film transport is disposed inside a spool 35. The rotating force of the motor 31 in the film winding direction is transmitted to the spool 35 with the speed of rotation reduced serially by a pinion gear 32, a sun gear 33 and a planet gear 34. Further, the sun gear 33 and the spool 35 are arranged to transmit rotating forces by means of internal gears.

The sun gear 33 is held in a rotatable manner by a base plate (not shown). The planet gear 34 is held in a rotatable manner through a pin 37 by a hole 36b formed in a planetary arm 36. Further, the planetary arm 36 is held to be swingable on a hole 36a thereof coaxially with the rotation axis of the sun gear 33. A friction spring 38 is arranged between the planet gear 34 and the planetary arm 36 to cause the clockwise and counterclockwise rotations of the sun gear 33 to bring about clockwise and counterclockwise revolving forces of the planet gear 34. The planet gear 34 is thus arranged to revolve either for the film winding or for the film rewinding according to the direction in which the motor 31 rotates.

The rotating force of the motor 31 in the film rewinding direction is transmitted to a fork gear 42 through the pinion gear 32, the sun gear 33, the planet gear 34, a first rewinding gear 39, a second rewinding gear 40 and a rewinding gear train 41.

The above-stated arrangement roughly represents a known film transport mechanism. A film winding action becomes possible when the film F is taken up and wound on the spool 35. The film winding action is thus performed by pulling the film F out from a film cartridge 43.

The planetary arm 36 is provided with a knob lock 44, a lock gear 45 and a pin 46, besides the above-stated parts of the film transport mechanism. The knob lock 44 has its rotation shaft 44a held by a hole 36c of the planetary arm 36 in a rotatable manner. Therefore, similarly to the planet gear 34, the knob lock 44 is arranged to be not only able to revolve around the sun gear 33 but also rotatable on the rotation shaft 44a.

A positioning pin 44b of the knob lock 44 is inserted through its elastic part into a positioning hole 36d of the planetary arm 36. Therefore, the rotatable range of the knob lock 44 is limited to a predetermined degree. Further, a small protruding part 36e is formed at the positioning hole 36d in such a way as to have the knob lock 44 stably set where the knob lock 44 abuts on the planetary arm 36 by rotating clockwise and counterclockwise. The knob lock 44 is provided further with a sector gear 44c. The sector gear 44c is arranged to be able to mesh with a lock gear 45 which is rotatably held through a pin 46 by a hole 36f of the planetary arm 36. The positional relation for intermeshing is such that the sector gear 44c is normally in mesh with the lock gear 45, and is not in mesh with the lock gear 45 only when the knob lock 44 comes to a position of abutting on the planetary arm 36 by rotating clockwise. Further, although the planetary arm 36 swings in association with the revolution of the planet gear 34, the lock gear 45 also revolves according to the swing of the planetary arm 36. The movement of the lock gear 45 is such that the lock gear 45 and the first rewinding gear 39 are in mesh with each other when the planet gear 34 is in mesh with the spool 35 for film winding, and are not in mesh with each other when the planet gear 34 is in mesh with the first rewinding gear 39 for film rewinding.

As shown in FIG. 9, a change-over spring 47 is a leaf spring of an angular (roof) shape. The change-over spring 47 is arranged to be not in mesh with the planet gear 34 when the planet gear 34 is either in its film winding position or in its film rewinding position, but is in mesh with the planet gear 34 while the planet gear 34 is in process of revolving from the film winding position to the film rewinding position and vice versa. When being in mesh with the planet gear 34, the change-over spring 47 generates a revolving force larger than a revolving force of the planet gear 34 which is generated by the friction spring 38.

These parts are retained in place by a keep plate 48. The keep plate 48 has a bent-up part 48a, which extends through a hole 36g of the planetary arm 36 to a position where the bent-up part 48a can abut on a release end surface 44d of the knob lock 44. However, the hole 36g is arranged such that, even when the planetary arm 36 swings in association with the revolution of the planet gear 34, the bent-up part 48a never comes to abut on the hole 36g of the planetary arm 36.

A back lid (not shown) can be opened by pushing a back-lid opening knob 49 downward as viewed in FIG. 8. The third embodiment has a mechanism arranged to inhibit an operation on the back-lid opening knob 49. The back lid, which is to be opened by operating the back-lid opening knob 49, is arranged in a known manner and is, therefore, omitted from the description. The back-lid opening knob 49 is provided with a knob abutting part 49a. The knob lock 44 is provided with a lock abutting part 44e. When the back-lid opening knob 49 and the knob lock 44 are in a positional relation to each other as described later, the lock abutting part 44e abuts on the knob abutting part 49a to restrain the back-lid opening knob 49 from being pushed down.

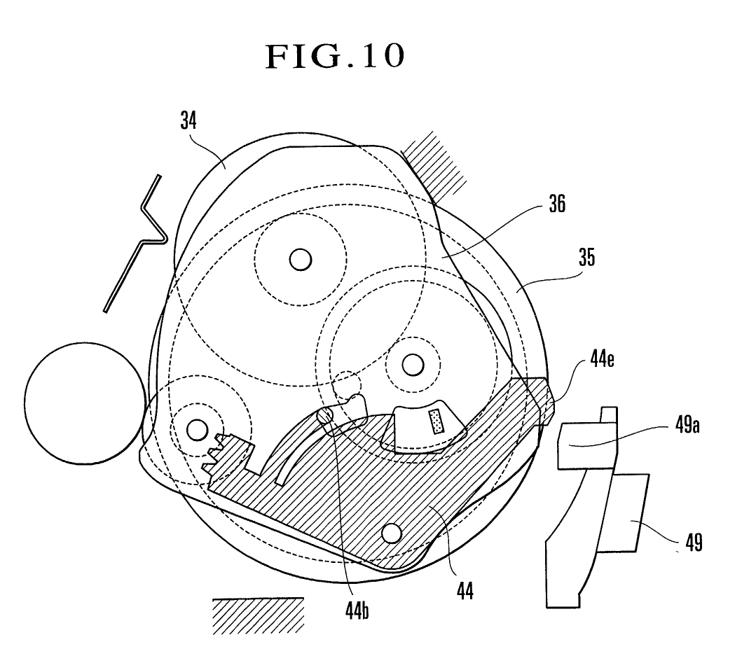

With the third embodiment arranged as described above, an erroneous-opening inhibiting mechanism, which is composed of the knob lock 44, the lock gear 45, the keep plate 48 and the change-over spring 47, operates as described below with reference to FIGS. 10 to 13. FIGS. 10 to 13 show only the essential parts of the third embodiment.

### AL Failure

FIG. 10 shows a state obtained in the event of an AL failure. In this state, the film transport is not actually performed although the planet gear 34 is in mesh with the spool 35 to cause the spool 35 to make film winding rotation. In this state, the back-lid opening knob 49 can be operated to open the back lid for reloading the film cartridge 43.

### Successful AL

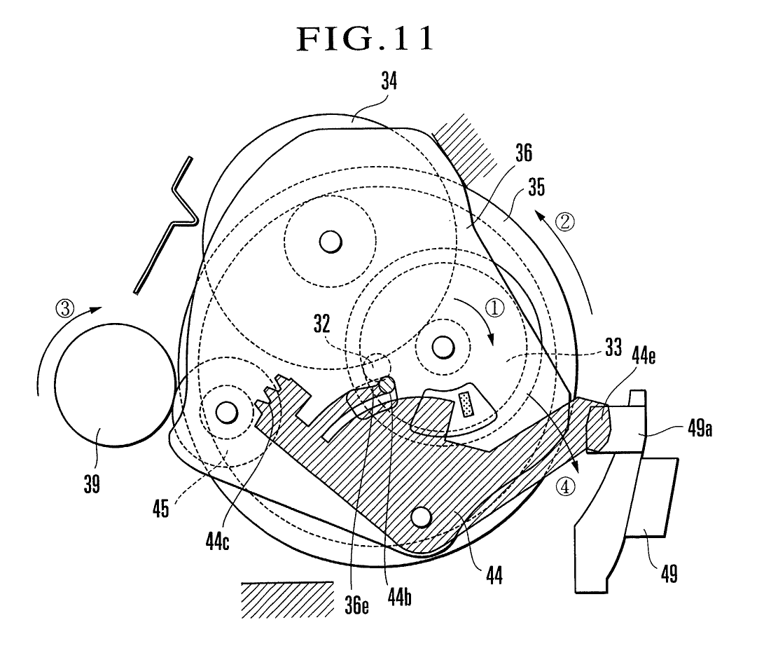

FIG. 11 shows a state obtained with an AL action successfully carried out. The rotation of the motor 31 is transmitted through the pinion gear 32, the sun gear 33 (\mathring{1}) and the planet gear 34 to the spool 35 (\mathring{2}) to cause the spool 35 to make film winding rotation with the film F taken up and round thereon.

With the AL action successfully carried out, when the film F is further pulled out from the film cartridge 43, the fork gear 42 begins to rotate counterclockwise. The rotating force of the fork gear 42 is transmitted to the first rewinding gear 39 to cause the first rewinding gear 39 to rotate clockwise (\mathring{3}). Then, the rotation of the first rewinding gear 39 eventually causes the lock gear 45 to rotate counterclockwise. In the state shown in FIG. 10, the knob lock 44 is stably held abutting on the planetary arm 36 at a position obtained by counterclockwise rotation. In the state shown in FIG. 11, however, the counterclockwise rotation of the lock gear 45 causes the knob lock 44 to rotate clockwise. When the knob lock 44 comes to a clockwise rotation abutting position, the knob lock 44 is stably held there by the planetary arm 36. At that time, as mentioned above, the sector gear 44c of the knob lock 44 disengages from the lock gear 45. However, since the positioning pin 44b of the knob lock 44 rides over the protruding part 36e of the planetary arm 36, the overriding force of the positioning pin 44b causes the sector gear 44c to disengage completely from the lock gear 45. Under the condition thus obtained, therefore, the lock gear 45 is left idly rotating.

The clockwise rotation of the knob lock 44 brings the lock abutting part 44e to a position where the lock abutting part 44e overlaps the knob abutting part 49a of the back-lid opening knob 49 (the lock abutting part 44e is just beneath the knob abutting part 49a in the state shown in FIG. 8). This makes the back lid no longer openable by operating the back-lid opening knob 49 downward as viewed in FIG. 8.

In the third embodiment, the erroneous-opening inhibiting mechanism is also arranged to become operative in association with the film F being substantially wound up after the successful AL action. However, in addition to that, a load imposed on the film transport operation in causing the knob lock 44 to rotate clockwise is arranged to disappear upon the completion of movement of the erroneous-opening inhibiting mechanism, and the lock gear 45 is left idly rotating. Therefore, unlike in the case of each of the first and second embodiments, no load is constantly imposed on the film transport operation after the completion of the action of the erroneous-opening inhibiting mechanism.

### Rewinding

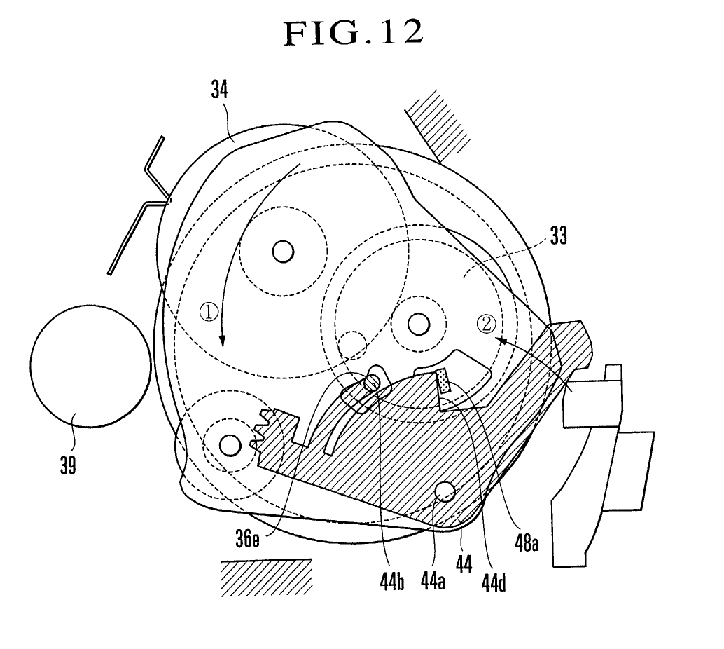

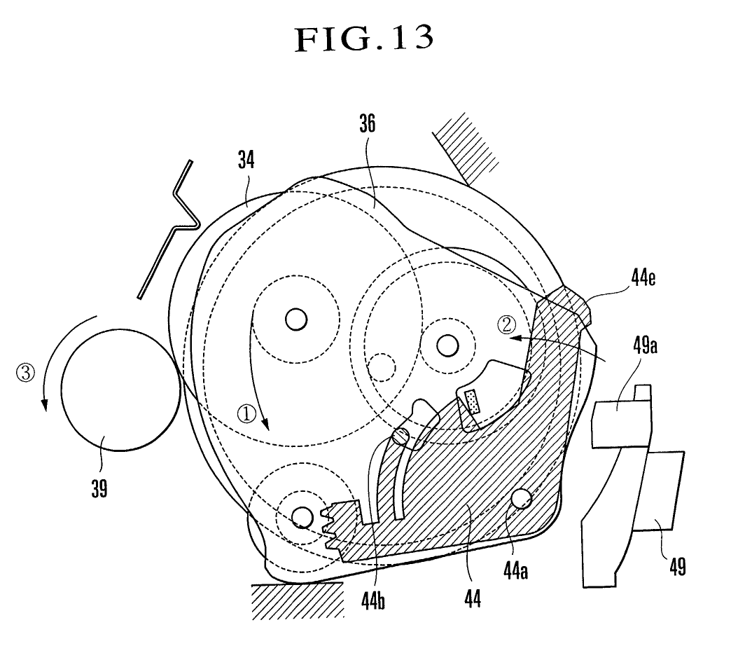

The movement of a mechanism arranged to cancel the action of the erroneous-opening inhibiting mechanism in association with the film rewinding action is next described. FIG. 12 shows a state obtained while the erroneous-opening inhibiting mechanism is in process of being released from its action. FIG. 13 shows a state obtained upon the completion of the release process.

Referring to FIGS. 12 and 13, when the motor 31 begins to rotate for film rewinding, the planet gear 34 comes to revolve counterclockwise to mesh with the first rewinding gear 39. At the same time, the knob lock 44 also comes to revolve counterclockwise around the sun gear 33 (\mathring{1}). The release end surface 44d of the knob lock 44 comes to abut on the bent-up part 48a of the keep plate 48. Then, the knob lock 44 comes to rotate counterclockwise on the rotation shaft 44a with respect to the planetary arm 36 (\mathring{2}), as shown in FIG. 12. When the knob lock 44 further rotates, there is obtained the state shown in FIG. 13. At this point of time, the planet gear 34 comes to mesh with the first rewinding gear 39. Then, the knob lock 44 also has rotated to reach a counterclockwise rotation abutting position on the planetary arm 36.

By virtue of this arrangement, the knob lock 44 is located at a position where the lock abutting part 44e does not overlap the knob abutting part 49a of the back-lid opening knob 49 (having moved out from beneath the knob abutting part 49a, as shown in FIG. 8). Under this condition, the back lid can be opened by operating the back lid opening knob 49.

The third embodiment is thus arranged to release or cancel the action of the erroneous-opening inhibiting mechanism also in association with the film rewinding action. However, since the action canceling process is finished before the film rewinding action is substantially performed, the same effect as the “recovery” action described in the first or second embodiment can be attained by stopping the motor 31 from rotating further at this point of time. Such an arrangement of the third embodiment ensures that the film is not completely pulled into the film cartridge like in the case of the “recovery” action of the first or second embodiment.

However, as apparent from the comparison of the state of FIG. 10 with that of FIG. 13, with the knob lock 44 at the counterclockwise rotation abutting position on the planetary arm 36, the back-lid opening knob 49 is not restrained from being operated irrespective as to whether the planet gear 34 is at its film winding position or at its film rewinding position. Further, the clockwise and counterclockwise rotation abutting positions of the knob lock 44 on the planetary arm 36 are reliably determined without fail by the positioning pin 44b in conjunction with the protruding part 36e of the planetary arm 36. Therefore, the arrangement of the third embodiment obviates the necessity of the “recovery” action of the first or second embodiment disclosed in the foregoing. However, the “recovery” action may be arranged to be performed in the event of the AL failure, as such an arrangement brings about no problem.

In the second embodiment, a force required for the release action is obtained from the revolving force of the planetary arm 21. For this purpose, however, the frictional force of the planet gear 7 must be arranged to be larger than a force normally required for change-over of revolution. The arrangement thus increases a load on the film transport operation.

In the case of the third embodiment, the release action also necessitates the revolving force of the planet gear 34 to be sufficiently large to allow the positioning pin 44b of the knob lock 44 to ride over the protruding part 36e of the planetary arm 36. However, in the third embodiment, the revolving force is obtained also from the intermeshing of the change-over spring 47 and the planet gear 34 in addition to the spring force of the friction spring 38. The intermeshing gives a larger revolting force than a revolving force obtained from the friction spring 38. The arrangement of the third embodiment, therefore, gives a sufficiently large force without fail. Besides, it gives no load when the change-over spring 47 and the planet gear 34 are not intermeshing. Therefore, with the change-over spring 47 and the planet gear 34 arranged to intermesh with each other before the release end surface 44d of the knob lock 44 comes to abut on the bent-up part 48a of the keep plate 48, the spring force of the friction spring 38 can be arranged to be just large enough for causing the planet gear 34, the planetary arm 36, the knob lock 44, the lock gear 45, etc., to revolve. The spring force then does not have to be such a large force that is required for the release action. Hence, the normal load on film transport operation can be lessened.

The third embodiment is thus arranged to obtain a force required for actuating and canceling the action of the erroneous-opening inhibiting mechanism without increasing a load normally imposed on the film transport operation as well as to attain the advantages of the first and second embodiments described in the foregoing.

### Fourth Embodiment

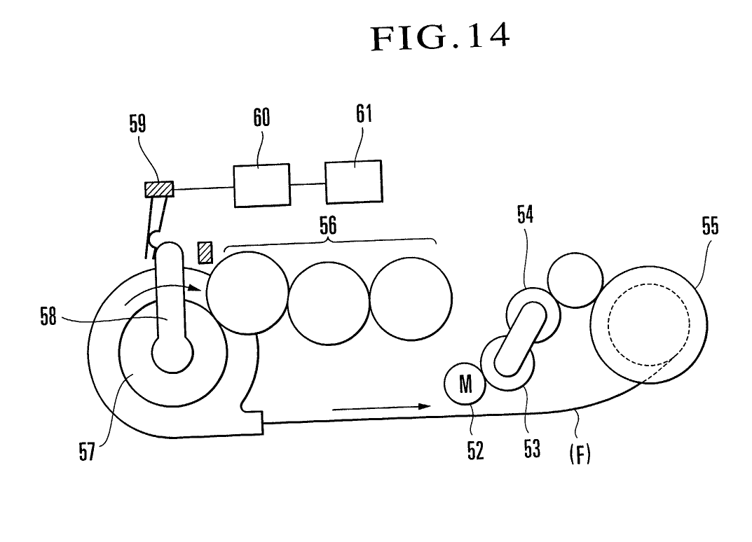

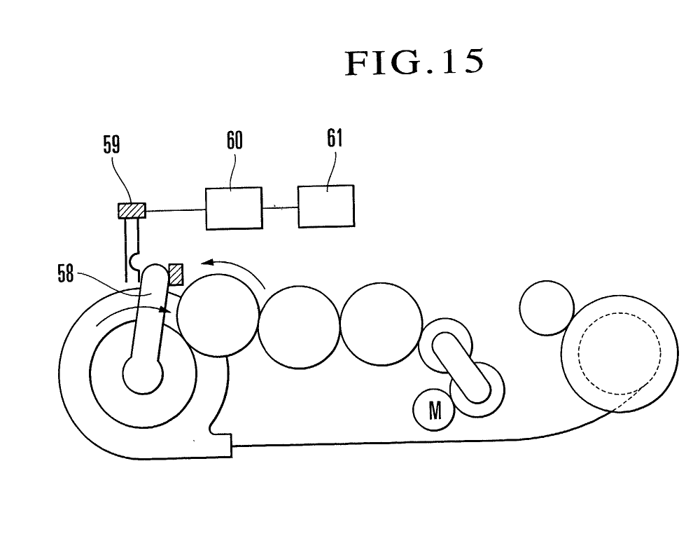

FIGS. 14 and 15 relate to a camera according to a fourth embodiment of the invention. FIG. 14 shows a film winding state, and FIG. 15 shows a film rewinding state.

Referring to FIGS. 14 and 15, the camera includes a motor 52, a sun gear 53, a planet gear 54, a spool 55, a film rewinding gear train 56 and a fork 57, which constitute a known film transport mechanism. The fork 57 is provided with a fork lever 58. The relation of the fork 57 to the fork lever 58 is similar to the relation between the fork gear 11 and the lock lever 15 in the first embodiment. In other words, the fork lever 58 is arranged to swing integrally with the fork 57 through friction. The camera is provided with a detecting switch 59 for detecting the swinging position of the fork lever 58. Control means 60 is arranged to control the action of a predetermined means 61 on the basis of the result of detection by examining the result of detection made by the detecting switch 59. The control means 60 is, for example, a microcomputer or the like. The predetermined means is, for example, any of various means including main switch operation inhibiting means, flash device light emission inhibiting means, shutter driving inhibiting means, etc.

With the fourth embodiment arranged as described above, the fourth embodiment operates similarly to the operation of the first embodiment. When the film F begins to substantially move with the AL action successfully carried out, the fork lever 58 turns on the detecting switch 59. However, when a film rewinding action is performed, as shown in FIG. 15, the detecting switch 59 turns off irrespective of the movement of the film F. Then, the turn-off signal of the detecting switch 59 is detected by the control means 60. The control means 60 then renders the above-stated predetermined means 61 operative.

By the above-stated arrangement of the fourth embodiment, any of functions of varied kinds can be temporarily inhibited from being performed during a period after the commencement of film rewinding and before the AL action is successfully carried out. The arrangement for inhibiting, for example, flash-device light emission or shutter driving, effectively prevents the electric energy of a battery from being wasted.

Further, if it is a main switch operation that is thus inhibited, unnecessary operations on the camera can be prevented not only to save electric energy of the battery but also to effectively lengthen the service life of each part of the camera. In addition to that, the inhibiting function can be carried out without using a member, such as a cartridge detecting contact piece, disposed at a part where it tends to become unclean.

1. A camera comprising:
a) an interlocking member arranged to act in association with a film moving in a winding direction thereof;
b) a detecting circuit arranged to detect whether or not said interlocking member has acted;
c) an action inhibiting circuit arranged to inhibit an action of said camera related to photo-taking; and
d) a control circuit arranged to cancel said action inhibiting circuit,
wherein said control circuit is rendered operative when said detecting circuit detects that said interlocking member has acted.

2. A camera according to claim 1, wherein said action inhibiting circuit is a circuit for inhibiting the action of a main switch of said camera.

3. A camera according to claim 1, wherein said action inhibiting circuit is a circuit for inhibiting a light emitting action of a flash device.

4. A camera according to claim 1, wherein said action inhibiting circuit is a circuit for inhibiting an exposure action.

5. A camera comprising:
a) an operation member operable for bringing a back lid from a closed state into an open state;
b) a lock member arranged to be displaceable between a first position in which said lock member permits an opening operation on said operation member and a second position in which said lock member inhibits the opening operation; and
c) an interlocking member arranged to displace said lock member from the first position to the second position in association with a film beginning to move in a winding direction thereof;
wherein the interlocking of said interlocking member with said lock member is cut off in response to said lock member having been displaced to the second position.

6. A camera comprising:
a) an operation member operable for bringing a back lid or a cartridge chamber lid from a closed state into an open state;
b) a lock member arranged to be displaceable between a first position in which said lock member permits an opening operation on said operation member and a second position in which said lock member inhibits the opening operation; and
c) a lock position varying member arranged to displace said lock member from the second position to the first position before an action of pulling a film into a film cartridge actually begins.

7. A camera according to claim 6, further comprising a planetary gear mechanism arranged to transmit an output of a drive source to one of a film winding gear train and a film rewinding gear train,
wherein said lock position varying member displaces said lock member from the second position to the first position in association with the revolution of said planetary gear mechanism from said film winding gear train to said film rewinding gear train.

8. A camera according to claim 7, wherein said lock position varying member displaces said lock member from the second position to the first position in association with the rotation of a sun gear made when said planetary gear mechanism revolves.

9. A camera according to claim 7, wherein said lock position varying member displaces said lock member from the second position to the first position in association with a swing of a planetary arm made when said planetary gear mechanism revolves.

10. A camera according to any one of claims 7 to 9, further comprising a revolution assisting member arranged to mesh with a planet gear when said planetary gear mechanism is in process of revolving and to act to cause said planet gear to generate, while said revolution assisting member is in mesh with said planet gear, a revolving force which is larger than a revolving force generated by said planet gear.
